(19) United States
(12) Patent Application Publication
(10) Pub. No.: US 2015/0005968 A1
(43) Pub. Date: Jan. 1, 2015

(54) APPARATUS AND METHOD FOR DETERMINING DEVICE PARTICIPATION IN AN ENERGY MANAGEMENT PROGRAM

(71) Applicant: ENERNOC, INC., Boston, MA (US)

(72) Inventor: Michael J. DOROUGH, Meridian, ID (US)

(21) Appl. No.: 14/317,309

(22) Filed: Jun. 27, 2014

Related U.S. Application Data
(60) Provisional application No. 61/841,732, filed on Jul. 1, 2013.

(51) Int. Cl. G06Q 50/06

(52) U.S. Cl. CPC G06Q 50/06
USPC 700/291

(57) ABSTRACT

A mechanism for determining device participation in an energy management program is provided. The mechanism includes a network operations center (NOC) and a device accountability system. The (NOC) commands one or more energy control devices to change one or more states responsive to energy management program events, where the one or more energy control devices respond to the NOC to indicate changed one or more states. The device accountability system is coupled to the NOC, and intercepts commands/responses from/to the NOC, and creates a time-correlated model comprising program participation parameters for each of the one or more energy control devices, where the time-correlated model is based upon message characteristics for the commands/responses, device data for the one or more energy control devices, and NOC data corresponding to the energy management program events and operator intervention events.

### CROSS-REFERENCE TO RELATED APPLICATIONS

This application claims the benefit of the following U.S. Provisional Applications, each of which is herein incorporated by reference for all intents and purposes.

| SERIAL | FILING | |
|---|---|---|
| NUMBER | DATE | TITLE |
| 61841732 | Jul. 1, 2013 | APPARATUS AND METHOD FOR DETER- |
| (ENER.0110) | | MINING DEVICE PARTICIPATION IN AN |
| | | ENERGY MANAGEMENT PROGRAM |

### BACKGROUND OF THE INVENTION

1. Field of the Invention

This invention relates in general to the field of energy management, and more particularly to an apparatus and method for determining device participation in an energy management program.

2. Description of the Related Art

The problem with energy resources such as electrical power, water, fossil fuels, and their derivatives (e.g., natural gas) is that the generation and consumption of a resource both vary with respect to time. In addition, the delivery and transport infrastructure limits instantaneous matching of generation and consumption. These resources are limited in supply and the demand for this limited supply is constantly fluctuating. As anyone who has participated in a rolling blackout will agree, the times are more and more frequent when resource consumers are forced to face the realities of limited resource supply.

Most notably, the electrical power generation and distribution industry has taken proactive measures to protect limited instantaneous supplies of electrical power by imposing financial disincentives such as peak demand charges and time-of-use (TOU) pricing for the creation of high peak demand and the consumption of electricity during peak demand periods. Heretofore, consumers merely paid for the total amount of power that they consumed over a billing period. Today most energy suppliers not only charge customers for the total amount of electricity they consume over the billing period, but they additionally bill the customers for their peak demand reading, that is, the greatest amount of energy that is used during a measured period of time. Additionally, energy suppliers are beginning to charge higher rates for power consumed during peak demand periods with mechanisms such as time-of-use pricing.

For example, consider a large agricultural concern that manages hundreds of energy consuming devices such as center-pivot irrigation rigs, deep-water pumps, sprinklers, turbines, and the like. If all of the devices operate at the same time, then the peak demand for that period is exceedingly high relative to periods where only a portion of the devices are in operation. Not only does the energy supplier have to provide for instantaneous generation of this power in conjunction with loads exhibited by its other consumers, but the distribution network that supplies this peak power must be sized such that it delivers the power to the loads. Consequently, it is standard practice today that customers who create high peak demand and consume electricity during peak demand periods are required to pay a surcharge to offset the costs of peak energy generation and distribution.

In addition to financial disincentives for contributing to peak demand, many utilities (e.g., Pacific Gas & Electric) offer financial incentives to customers to actively reduce peak and overall demand through participation in so called demand response and energy efficiency programs, as well as to upgrade to more efficient and controllable building equipment. In demand response programs, utilities pay incentives for reducing energy consumption during peak demand periods such as hot summer afternoons. In energy efficiency programs, utilities pay incentives for improvements that lead to more efficient utilization of energy. Since most customers are not necessarily trained or equipped to fully exploit these savings opportunities, a number of energy management companies (e.g., ENERNOC, INC.®) serve as intermediaries to facilitate these programs offered by the utilities. Energy management companies (EMCs) enable participation in demand response programs, they monitor and manage peak demand creation, they optimize consumption in light of time-of-use pricing, and perform other services such as energy efficiency audits.

Utilities require by contract that demand management service providers measure and verify curtailed load during demand response events in order to be paid for the service. Heretofore, the bulk of the electrical loads employed in demand response programs have been large industrial loads that customers are willing to shut down during a demand response event. These large loads have known electrical footprints and their curtailment can easily be measured and verified. In more recent times, though, EMCs are beginning to extend demand response programs beyond the large footprint context into operations consisting of a substantial number of energy consuming devices as the curtailable load.

Many of the devices that are able to be temporarily turned off, idled, or placed into an energy saving mode are small, simple, unsophisticated devices such as water pumps and space heater, and they have limited communications capabilities. In addition, the communications infrastructure necessary to communicate with these devices may span multiple mediums, including both wired systems (e.g., Ethernet, asynchronous serial interfaces, and digital subscriber lines (DSL)) and wireless systems (e.g., cellular, Wi-Fi, long range wireless, low power mesh networks). These devices are typically controlled and managed from a central facility, commonly known as a Network Operations Center (NOC). Communications with the devices is further complicated by periodic disruptions over the varied communications networks used, transient failures of the devices themselves, and/or intentional or unintentional tampering with the operation of the devices. Further complicating factors include the ability of equipment owners and equipment maintenance personnel to change the operating states of these devices by either directly interacting with the devices (e.g., turning the devices on, off, or placing them in a different operating mode) and overriding NOC control, or by changing the devices' operating states through a local or remote web-based user interface.

If a demand-response program is to successfully operate, operating states of these large networks of devices must be accurately determined and control of the devices must be reliably maintained.

Therefore, what is needed is a technique that accounts for device participation in an energy management program in the presence of communication network failures, device failures, and intentional/unintentional tampering.

In addition, what is needed is a device accountability apparatus and method that improves the level of accounting and reporting of device participation in an energy management program over that which has heretofore been provided.

### SUMMARY OF THE INVENTION

The present invention, among other applications, is directed to solving the above-noted problems and addresses other problems, disadvantages, and limitations of the prior art. The present invention provides a superior technique for accurately determining the participation of a number of energy consuming devices in an energy management program. In one embodiment, a mechanism for determining device participation in an energy management program is provided. The mechanism includes a network operations center (NOC) and a device accountability system. The (NOC) commands one or more energy control devices to change one or more states responsive to energy management program events, where the one or more energy control devices respond to the NOC to indicate changed one or more states. The device accountability system is coupled to the NOC, and intercepts commands/responses from/to the NOC, and creates a time-correlated model comprising program participation parameters for each of the one or more energy control devices, where the time-correlated model is based upon message characteristics for the commands/responses, communications network and transport layer operating characteristics, device data for the one or more energy control devices, and NOC data corresponding to the energy management program events and operator intervention events.

One aspect of the present invention contemplates a device participation and accountability apparatus. The apparatus has a network operations center (NOC) that commands one or more energy control devices to change one or more states responsive to energy management program events, where the one or more energy control devices respond to the NOC to indicate changed one or more states. The NOC includes a device accountability system that intercepts commands/responses from/to the NOC. The device accountability system has a modeling element that creates a time-correlated model comprising program participation parameters for each of the one or more energy control devices, where the time-correlated model is based upon message characteristics for the commands/responses, communications network and transport layer operating characteristics, device data for the one or more energy control devices, and NOC data corresponding to the energy management program events and operator intervention events.

Another aspect of the present invention comprehends a method for determining device participation in an energy management program. The method includes: from a network operations center (NOC), commanding one or more energy control devices to change one or more states responsive to energy management program events, where the one or more energy control devices respond to the NOC to indicate changed one or more states; and intercepting commands/responses from/to the NOC, and creating a time-correlated model comprising program participation parameters for each of the one or more energy control devices, where the time-correlated model is based upon message characteristics for the commands/responses, device data for the one or more energy control devices, and NOC data corresponding to the energy management program events and operator intervention events.

### BRIEF DESCRIPTION OF THE DRAWINGS

These and other objects, features, and advantages of the present invention will become better understood with regard to the following description, and accompanying drawings where:

FIG. 1 is a block diagram illustrating a device participation and accountability mechanism according to the present invention;

FIG. 2 is a block diagram depicting the device accountability system of FIG. 1;

FIG. 3 is a flow diagram featuring an exemplary device error recovery method according to the present invention;

FIG. 4 is a flow diagram showing an exemplary communications error recovery method according to the present invention; and

FIG. 5 is a flow diagram illustrating an exemplary safe operation control method according to the present invention.

### DETAILED DESCRIPTION

Exemplary and illustrative embodiments of the present invention are described below. In the interest of clarity, not all features of an actual implementation are described in this specification, for those skilled in the art will appreciate that in the development of any such actual embodiment, numerous implementation specific decisions are made to achieve specific goals, such as compliance with system related and business related constraints, which vary from one implementation to another. Furthermore, it will be appreciated that such a development effort might be complex and time consuming, but would nevertheless be a routine undertaking for those of ordinary skill in the art having the benefit of this disclosure. Various modifications to the preferred embodiment will be apparent to those skilled in the art, and the general principles defined herein may be applied to other embodiments. Therefore, the present invention is not intended to be limited to the particular embodiments shown and described herein, but is to be accorded the widest scope consistent with the principles and novel features herein disclosed.

The present invention will now be described with reference to the attached figures. Various structures, systems, and devices are schematically depicted in the drawings for purposes of explanation only and so as to not obscure the present invention with details that are well known to those skilled in the art. Nevertheless, the attached drawings are included to describe and explain illustrative examples of the present invention. The words and phrases used herein should be understood and interpreted to have a meaning consistent with the understanding of those words and phrases by those skilled in the relevant art. No special definition of a term or phrase (i.e., a definition that is different from the ordinary and customary meaning as understood by those skilled in the art) is intended to be implied by consistent usage of the term or phrase herein. To the extent that a term or phrase is intended to have a special meaning (i.e., a meaning other than that understood by skilled artisans) such a special definition will be expressly set forth in the specification in a definitional manner that directly and unequivocally provides the special definition for the term or phrase.

### DEFINITIONS

Integrated Circuit (IC): A set of electronic circuits fabricated on a small piece of semiconductor material, typically silicon. An IC is also referred to as a chip, a microchip, or a die.

Central Processing Unit (CPU): The electronic circuits (i.e., “hardware”) that execute the instructions of a computer program (also known as a “computer application” or “application”) by performing operations on data that include arithmetic operations, logical operations, and input/output operations.

Microprocessor: An electronic device that functions as a CPU on a single integrated circuit. A microprocessor receives digital data as input, processes the data according to instructions fetched from a memory (either on-die or off-die), and generates results of operations prescribed by the instructions as output. A general purpose microprocessor may be employed in a desktop, mobile, or tablet computer, and is employed for uses such as computation, text editing, multimedia display, and Internet browsing. A microprocessor may also be disposed in an embedded system to control a wide variety of devices including appliances, mobile telephones, smart phones, and industrial control devices.

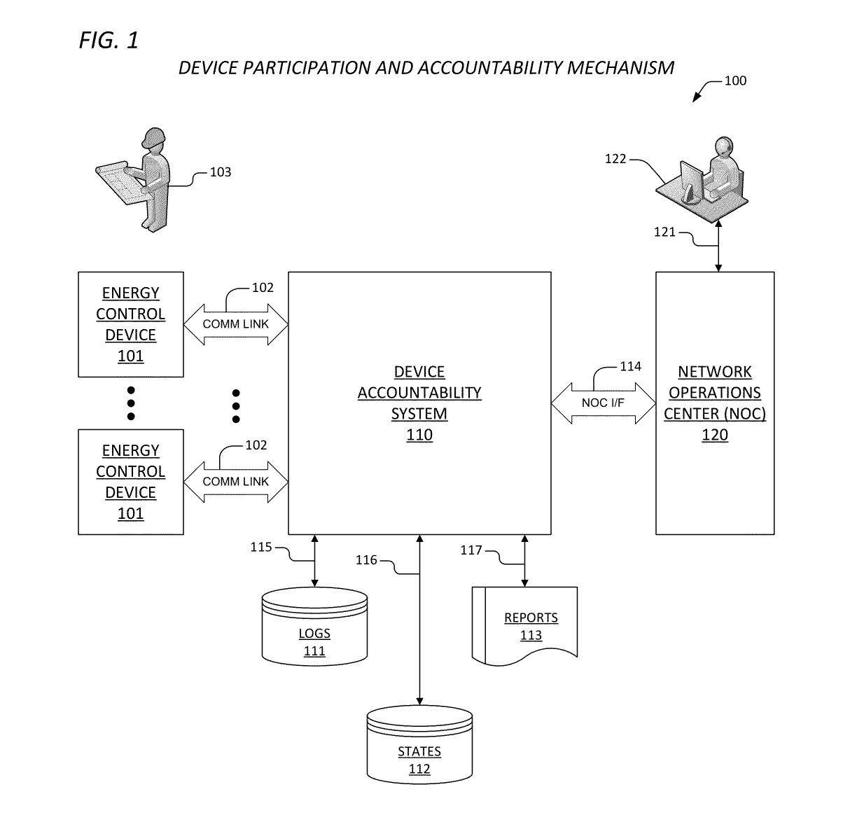

In view of the above background discussion on energy management and associated present day techniques that are employed to determine and verify participation in energy management programs, a discussion of the present invention will now be presented with reference to FIGS. 1-5. The present invention provides a superior technique for determining and accounting for participation of various devices in such programs in the presence of transient device errors, network disruptions, tampering, and/or operator intervention, thus overcoming the above noted and other disadvantages and limitations in the art. Accordingly a system and method are provided for near-real-time correlation of device state with a corresponding energy management program's contractual requirements in a manner that is effective irrespective of media types and transport protocols over which device states are communicated. By utilizing a technique that focuses on state-oriented monitoring of device control and status messages, transport layer messages, and program requirements, the system according to the present invention provides for a correlated accounting of device participation in a corresponding energy reduction program throughout a given program event. In addition, when device errors, network disruptions, tampering, and/or operator interventions occur, the present invention provides techniques for active intervention in order to restore device state awareness and control.

Turning to FIG. 1, a block diagram is presented illustrating a device participation and accountability mechanism 100 according to the present invention. The mechanism may include one or more energy control devices 101 that are coupled to a device accountability system 110 via one or more communications links 102. The device accountability system 110 is coupled to a device logs database 111 via a first bus 115, an operational states database 112 via a second bus 116, and may generate one or more reports 113 via bus 117. The device accountability system 110 is additionally coupled to a network operations center (NOC) 120 via a NOC interface 114. One or more remote personnel 103 may interact with the one or more energy control devices 101 as will be further described below. One or more NOC personnel 122 may interact with the NOC 120 via one or more links 121 to initiate program events, issue commands, view reports 113, and perform other related program event supervisory tasks.

For purposes of the present application, the devices 101 may include any of a number of controllable devices, where control is applied directly or remotely to modify energy consumption for reasons of energy management within the constraints of an energy management program. Though typified by electrical demand response programs, the present inventor notes that the present invention also comprehends other forms of energy management including, but not limited to, natural gas, water, and fuels of all types. Given such an understanding, participation of the devices 101 in a demand response program will be described in order to clearly teach relevant aspects of the present invention without sacrificing clarity by referring to other types of energy management programs.

Accordingly, the devices 101 may include, but are not limited to, center-pivot irrigation rigs, deep-water pumps, sprinklers, turbines, space heaters, coolers, and the like. The devices 101 may be “controlled” from the NOC 120 by communications over the one or more of the communications links 102. Control of a device 101 may be affected by direct receipt of commands from the NOC 120 over one or more of the communications links 102 where the device 101 itself implements operational state changes directed by the commands. Alternatively, control of a device 101 may be affected by receipt of commands from the NOC 120 over one or more of the communications links 102 by one or more remote personnel 103, where the one or more remote personnel 103 implement operational state changes directed by the commands on the device 101. For purposes of the present application, the communication links 102 may include, but are not limited to wired networks, cellular networks, Wi-Fi networks, and long range wireless networks. Each of the communications links 102 may additionally comprise a combination of the above noted network types. In addition, one or more of the communication links 102 may be coupled to an individual device 101 for purposes of redundancy or separation of control and reporting of operational state.

In one embodiment, external to the context boundary of the communications links 102, the energy control devices 101 may include one or more different types of cellular modem transports. The devices 101 may employ a MOTOROLA® C24 modem with 1XRTT transport protocol. In another embodiment, other devices 101 may enable seamless connectivity over code division multiple access (CDMA) networks. In yet another embodiment, selected ones of the devices 101 may comprise general packet radio service (GPRS) cellular modems. CDMA modems are uniquely identified by a mobile equipment identifier (MEID), whereas GPRS modems are uniquely identified by an integrated circuit card identifier (ICCID). Operationally, the above mentioned disjoint cellular modem transports are in turn abstracted into a high-level objected-oriented hierarchy of message types specifically designed to meet the requirements of the energy management problem domain.

As one skilled in the art will appreciate, an energy management program may be performed under control of the NOC 120 on behalf of an energy provider in order to control aggregate consumption of energy in a given geographical region during a specified time interval. More specifically, with respect to electrical demand management, the NOC may implement a demand response program for the specified time interval where the devices 101 in the given region are controlled in order to reduce electrical demand during the interval. In accordance with device type, a device 101 may be turned off, or it may be placed in an operational state that reduces electrical demand. Alternatively, a device 101 that consumes a substantial amount of energy may be turned off, while one or more backup devices 101 may be turned on to perform the function of the device 101, while reducing the aggregate energy consumption. Other variations of control are contemplated. As noted above, control of the devices 101 may be direct or indirect.

As one skilled in the art will also appreciate, for a NOC company to recover financial incentives for participation of the devices 101 in the energy management program, participation of the devices 101 in one or more program events, the company must provide the energy provider with proof of participation, more often than not in the form of reports 223, whether in written or electronic form. And to implement participation accountability, protocols are established by the NOC 120 for reporting of operational status of each of the devices 101 at regular intervals during the program events. In one embodiment, the regular intervals are 5-minute intervals. Depending on device type, the operational states may include, but are not limited to, on/off state, speed, direction, and any other type of status information that may be required to confirm that a device 101 is in the operational state that was directed by commands from the NOC 120.

As one skilled in the art will further appreciate, a significant number of situations may occur that may temporarily or permanently preclude a given device 101 from participating in an energy management program, or that may preclude verification at the NOC 120 of the given device's participation. Such situations may include, but are not limited to, transient device failures, disruptions of networks corresponding to the communications links 102, tampering, and/or operator intervention. Operationally thus, the device accountability system 110 provides for accounting and verification of operational states for the one or more devices 101 during the program events by intercepting communications between the NOC 120 and the devices 101, and interpreting those communications in the presence of failure situations to improve reporting of the device's participation in program events. The accountability system 110 may additionally utilize communications network and transport layer operating characteristics (e.g., bandwidth, latency, connection requirements, timeout times) to redirect communications between the NOC 120 and a device 101 over one or more alternate communication links 102 if it is determined that a primary communication link 102 is undergoing transient or permanent failure. The accountability system 110 may further utilize specific device operational data to determine if tampering or operator intervention has occurred. The accountability system 110 may moreover utilize device information in correlation with operational state information to modify or supplement operational state commands from the NOC 120 to a device 101 to enable more accurate state changes that increase the efficiency of the device's participation in the program events. The accountability system 110 may yet additionally utilize device information in correlation with operational state information to inform the NOC 120 that operational state commands to a given device 101 may be modified or supplemented such that the given device's participation in the program events is increased. Advantageously, the device accountability system 110 performs all of the above noted functions without requiring any changes to an existing NOC 120. Consequently, by adding the device accountability system 110 to an existing NOC configuration 120, functionality of the overall system is improved due to the device accountability system's ability to distinguish communications errors from device participation errors, and to automatically restore operation of devices with transient errors.

In one embodiment, the device accountability system 110 comprises one or more application programs executing on one or more central processing units (CPUs) within the NOC 120. In another embodiment, the device accountability system 110 comprises a separate system collocated with the NOC 120, upon which device accountability application programs execute. Other embodiments comprehend service specific hardware elements and programmed CPUs that are configured for execution of the device accountability functions disclosed herein.

The device accountability system 110 may comprise hardware and one or more applications programs disposed in memory (not shown). The application programs control interface elements (not shown) to intercept messages transmitted between the devices 101 and the NOC 120, both incoming messages and outgoing messages. The accountability system 110 may time tag the intercepted messages and store resulting time-tagged messages in the device log database 111. The system 110 may further comprise a modeling element (not shown), as will be described in further detail below, that creates and maintains a time-correlated model for each devices 101. The model determines program participation parameters which include, but are not limited to, operating states, corresponding operating interactions, corresponding energy reduction program's program events, and communications networks' statuses. These parameters may be stored in and accessed from the operational states database 112. In one embodiment, the modeling element correlates these statuses and states to generate device accountability reports 113 for each of the energy control devices 101 indicating whether or not the energy control devices 101 have participated in corresponding required program events. The accountability reports 113 may by either near-real-time reports or non-real-time reports.

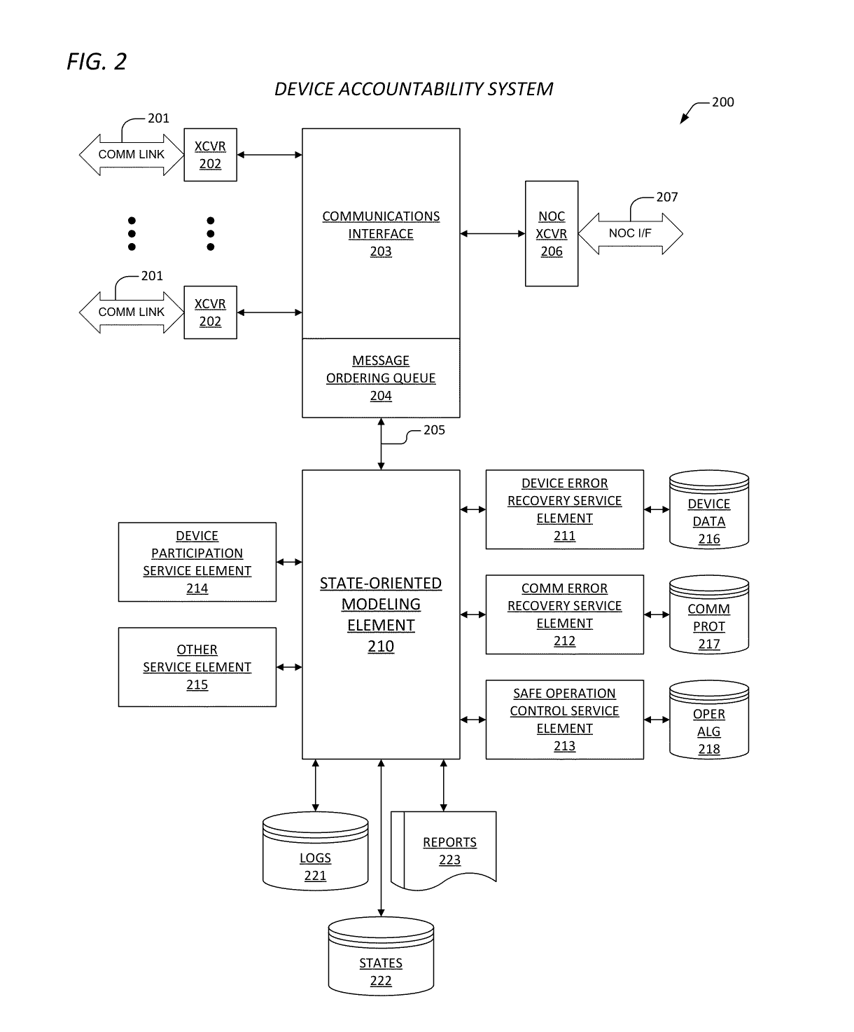

Turning now to FIG. 2, a block diagram is presented depicting the device accountability system 200 of FIG. 1. The system includes one or more device data transceivers 202 that intercept messages corresponding to each of the energy control devices (not shown) over each of the communications links 201 discussed above with reference to FIG. 1. The device transceivers 202 are coupled to a communications interface 203 that is coupled to a message ordering queue 204. The system 200 also includes a NOC data transceiver 206 that intercepts messages to/from the NOC (not shown) via NOC interface 207, and corresponding to each of the energy control devices. In one embodiment, each of the messages noted above are time stamped and stored in a log database 221. In one embodiment, messages received out of order are time-ordered and placed in the message ordering queue 204 in order to supplement determination of device state and to more accurately generate reports 223 for device participation in program events. In one embodiment, each message is inspected upon receipt and, if necessary, duplicate messages are eliminated. Since the messages are ordered according to time, they are thus forwarded to the NOC in correct order.

The system 200 further includes a state-oriented (or, “stateful”) modeling element 210 that is coupled to the message ordering queue 204 via bus 205. The modeling element 210 analyzes each of the messages in the queue 204 to determine operating parameters for the devices including, but not limited to, operating state, operating state changes, and message characteristics such as, but not limited to, time, delivery latency, number of retries, communication and device errors, temporal characteristics about previous, current, and future state, and communication network 201 used. These parameters are stored/accessed in/from an operational states database 222. The modeling element 210 may also draw upon device data provided by the NOC to determine the above noted device characteristics and parameters. The device data includes, but is not limited to, device type, model number, serial number, location, physical interaction interfaces, communications capabilities, operating states, and degraded states. NOC data corresponding to energy program events is also employed by the modeling element 210, and this data is correlated to device status messages as stored in the log database 221. NOC data corresponding to operator intervention events is also employed by the modeling element 210, and this data is correlated to device status messages as stored in the log database 221.

In one embodiment, bus 205 includes a message bus and queue 204 comprises a plurality of durable transactional message queue pairs (i.e., inbound and outbound) that serve to buffer adjacent services described in more detail below that may be processing messages inside of the state oriented modeling element 210. Each message type is dedicated to a particular inbound or outbound abstract message data type.

The modeling element 210 is also coupled to a plurality of service elements including a device participation service element 214, a device error recovery service element 211, a communication error recovery element 212, a safe operation control service element 213, and one or more additional service elements 215. In one embodiment, event-driven and periodic model updates are provided by the modeling element to the plurality of service elements 211-215. The error recovery service element 211 is coupled to a device data database 216 that may comprise the device data obtained from the NOC as described above. The communications error recovery element 212 is coupled to a communications protocols database 217 that may comprise parameters corresponding to each of the communication networks 201. The safe operation control service element 213 is coupled to a device operational algorithms database 218 that may comprise operating algorithms obtained from the NOC for one or more of the devices.

In one embodiment, one or more of the plurality of service elements 211-215 may initiate messages to the NOC or to one or more of the energy control devices in order to increase device participation in program events, to more accurately determine device participation, to utilize alternative networks 201 in the presence of network failures, to ensure safe operation of one or more of the devices, and to perform other functions that may be required to accurately model and reflect device participation.

In operation, the modeling element 210 updates time correlated events, and generates a model update in the form of one or more device accountability reports 223 that indicate near-real-time and/or non-real-time reports of participation in energy programs for each of the energy control devices.

Another aspect of this invention contemplates mechanisms for reconciling device state with explicit and implicit opt-in and opt-out events, in order to facilitate program participation accounting. This service may be disposed within the other service element 215 and operates by monitoring any status change to a device, as well as monitoring event changes and operator interaction with devices to determine if the device has opted to participate during an opt-in period (as determined by program requirements) or if it has opted to not participate during an opt-out period. Results of this additional service are posted by the modeling element 210 in device accountability reports 223.

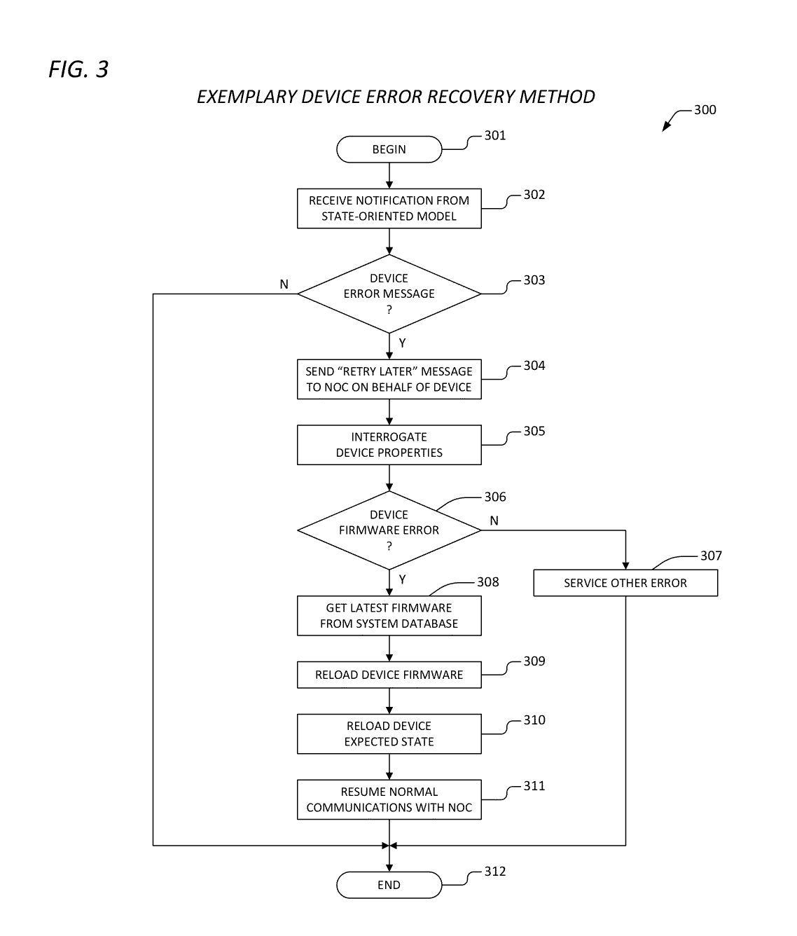

Referring now to FIG. 3, a flow diagram 300 is presented featuring an exemplary device error recovery method according to the present invention. The method may be employed by the device error recovery element 211 in the accountability system 200 of FIG. 2 in order to enable the accountability system to reestablish communications with an energy control device that comprises defective firmware. In this embodiment, communication is reestablished without NOC intervention. Accordingly, the modeling element updates the state of the energy control device and access to the updated model is provided to a device recovery service. As a result, the error is corrected as the device recovery service initiates messages to the energy control device to reload firmware that executes on the energy control device, thus enabling communications to resume. Subsequently, the NOC retries the request and the device responds successfully.

Flow begins at block 301, where the NOC has requested information from an energy control device and the device has responded with a communications error. According to the present invention, the error message is intercepted by a corresponding communications link 201 as the message propagates to the NOC. The message is time-tagged, entered into the message queue 204, and is processed by the state-oriented modeling element 210. Flow then proceeds to block 302.

At block 302, the modeling element 210 notifies the device error recovery service element 211 that a message from the device has been received. Flow then proceeds to decision block 303.

At decision block 303, an evaluation is made by the error recovery service element 211 to determine if the received message is a device error message. If not, then flow proceeds to block 312. If so, then flow proceeds to block 304.

At block 304, the error recovery service element 211 directs the modeling element 210 to send a “retry later” message to the NOC on behalf of the device that sent the error message. Flow then proceeds to block 305.

At block 305, the error recovery service element 211 directs the modeling element 210 to interrogate the properties of the device that sent the error message. Flow then proceeds to decision block 306.

At decision block 306, an evaluation is made to determine if the properties indicate a device firmware error. If so, then flow proceeds to block 308. If not, then flow proceeds to block 307.

At block 307, the error indicated by the properties is serviced. Flow then proceeds to block 312.

At block 308, the latest firmware for the device is retrieved from the device database 216. Flow then proceeds to block 309.

At block 309, the error recovery service element 211 directs the modeling element 210 to initiate messages to the device to reload its firmware with that obtained in block 308. Flow then proceeds to block 310.

At block 310, the error recovery service element 211 transmits one or more messages to the device in order to restore the state of the device base upon state information stored in the states database 222 for the device. Flow then proceeds to 311.

At block 311, the error recovery service element 211 directs the modeling element 210 to resume normal communications with the NOC regarding transmissions between the NOC and the device in question. Flow then proceeds to block 312.

At block 312, the method completes.

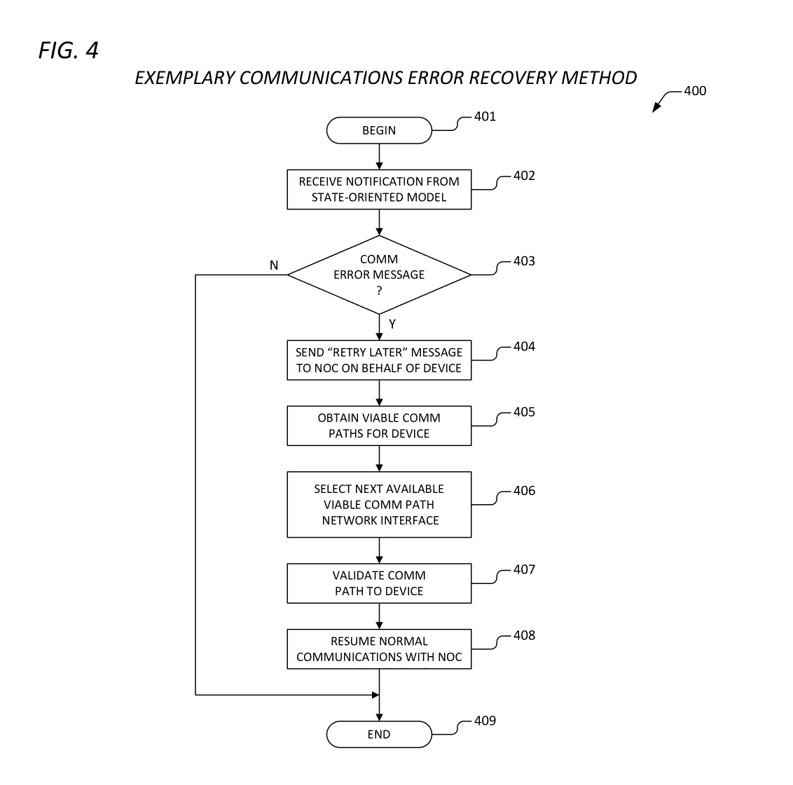

Now turning to FIG. 4, a flow diagram 400 is presented showing an exemplary communications error recovery method according to the present invention. The method may be employed by the communications error recovery element 212 in the accountability system 200 of FIG. 2. This exemplary method enables the accountability system 200 according to the present invention to reestablish communications with an energy control device, where the communications break is due to an error over a given communication network 201 through which a NOC-transmitted message to the energy control device was transmitted with errors. As such, the present invention comprehends techniques for improving disruption tolerance of devices, while maintaining a state-oriented awareness of the devices' participation in energy reduction events. In the event that verifiable device state and participation are temporarily lost, the system 200 will automatically recover the state from the device and will reconcile the participation reports 223 to accurately show device participation. The method thus reduces the likelihood of a communication disruption being misrepresented as a loss of device participation since device operating state does not necessarily correlate with communications state.

As noted above, the accountability system 200 models the state of each energy control device via the modeling element 210, and also monitors each message that propagates between devices and the NOC. Accordingly, in one embodiment, the state of the devices is known to be accurate as of transmission/receipt of a last message. If a communications error occurs between the NOC and a given energy control device, the communications error recovery service element 213 is employed to reestablish communications with the device. Upon reestablishment of communications, a log that may be disposed with the given energy control device may be examined by the device participation service element 214. Resulting data from the device log is accordingly employed to determine the operating state of the device during the period of communications disruption. Upon determination of the operating state, the device participation service element 214 publishes the reconciled information about the device activities in an accountability log 221, so that exact periods of participation are known. The present invention therefore reduces the likelihood of a communication disruption being misrepresented as a loss of device participation since device operating state does not necessarily correlate with communications state.

Flow begins at block 401, where a message from one of the devices is received by the device accountability system 200 over one of the communications links 201. The message is time-tagged, entered into the message queue 204, and is processed by the state-oriented modeling element 210. Flow then proceeds to block 402.

At block 402, the modeling element 210 notifies the communications error recovery service element 212 that a message from the device has been received. Flow then proceeds to decision block 403.

At decision block 403, an evaluation is made by the error recovery service element 212 to determine if the received message is a communications error message. If not, then flow proceeds to block 409. If so, then flow proceeds to block 404.

At block 404, the error recovery service element 212 directs the modeling element 210 to send a “retry later” message to the NOC on behalf of the device that sent the error message. Flow then proceeds to block 405.

At block 405, the error recovery service element 212 directs the modeling element 210 to obtain viable communications paths for the device from the communications protocols database 217. Flow then proceeds to block 406.

At block 406, the error recovery service element select the next available viable communication path for the device. Flow then proceeds to block 407.

At block 407, communications with the device is established and the communication path selected in block 406 is tested for expected operation. Flow then proceeds to block 408.

At block 408, the error recovery service element 212 directs the modeling element 210 to resume normal communications with the NOC regarding transmissions between the NOC and the device in question. Flow then proceeds to block 409.

At block 409, the method completes.

The method of FIG. 4 is provided to teach how the communications error recovery service element 212 enables functionality in the presence of a recoverable communications network error, where the device itself has received a command from the NOC in error, and has responded with an error message. However, one skilled in the art will appreciate that the error recovery service element 212 can be adapted to restore functionality in the presence of a recoverable communications network error, where the device itself has not responded with an error message. In such a case, the service element 212 has knowledge of communications network protocol parameters (e.g. timeout), and as a result of time-tagging the NOC command, a determination can be made that there is a communications network error, and the steps described above with reference to blocks 404-409 are executed.

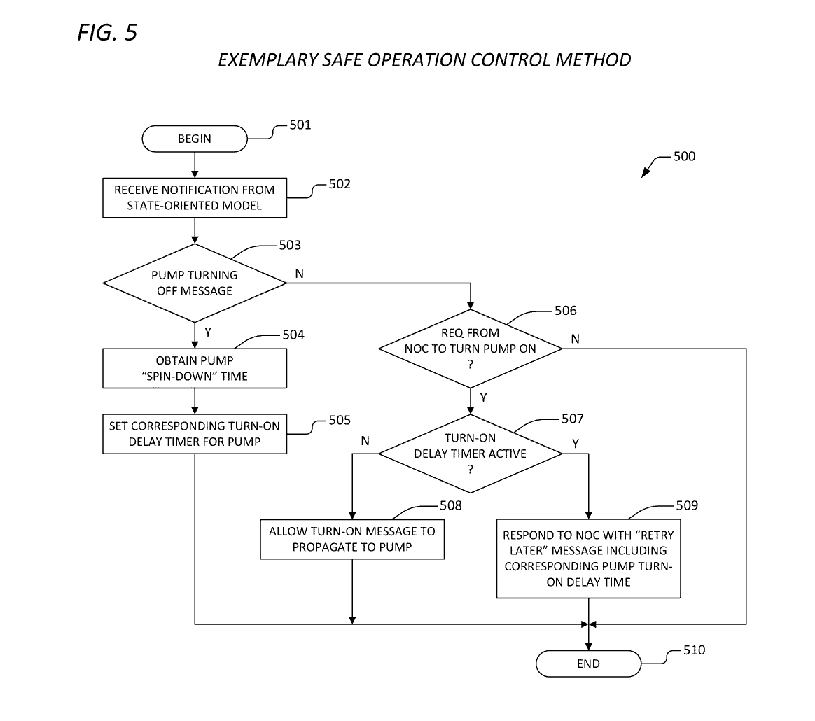

Referring to FIG. 5, is a flow diagram 500 is presented illustrating an exemplary safe operation control method according to the present invention. The method may be employed by the safe operation control service element 213 in the accountability system 200 of FIG. 2. The method depicts a technique for safely interacting with devices. The flow diagram depicts 500 interaction for safe operation of a deep well water pump for purposes of clearly teaching this aspect of the present invention. The present inventor notes that with this example, those skilled in the art will be enabled to adapt the flow below to comprehend safe operation of other devices. In a water pump, transitioning from on to off state, its impeller blades may stop and reverse until the water pressure on the outlet side of the pump is reduced. If the pump were to be turned on during this time of reverse rotation, the pump unit could be damaged. In this case, the modeling element 210 maintains a detailed understanding of the pump device under control via services from the control service element 213, which utilizes safe operating data that is stored in the operational algorithms database 218. When the pump is turned off, the accountability system 200 may instantiate a timer, or interrogate a pump tachometer sensor, for example, in order to guarantee that the pump is not turned on before the impeller blades stop.

Flow begins at block 501, where a message from one of the devices is received by the device accountability system 200 over one of the communications links 201. The message is time-tagged, entered into the message queue 204, and is processed by the state-oriented modeling element 210. Flow then proceeds to block 502.

At block 502, the modeling element 210 notifies the safe operation control service element 214 that a message from the device has been received. Flow then proceeds to decision block 503.

At decision block 503, an evaluation is made to determine if the message is a pump turning off status message intended for the NOC. If so, then flow proceeds to block 504. If not, then flow proceeds to decision block 506.

At block 504, the service element 214 obtains pump spin-down time from the operating algorithms database 218. Flow then proceeds to block 505.

At block 505, the service element 214 establishes a turn-on delay timer for the pump. Flow then proceeds to block 510.

At decision block 506, an evaluation is made to determine if a request from the NOC has been received to turn the pump on. If so, then flow proceeds to decision block 507. If not, then flow proceeds to block 510.

At decision block 507, an evaluation is made to determine if a turn-on delay timer for the pump is active. If so, then flow proceeds to block 509. If not, then flow proceeds to block 508.

At block 508, the accountability system 200 allows the turn-on message to propagate to the pump. Flow then proceeds to block 510.

At block 509, the accountability system responds to the NOC with a “retry later” message that includes the pump turn-on time established in block 505. Flow then proceeds to block 510.

At block 510, the method completes.

The accountability system 200 according to the present invention is configured to perform the functions and operations as discussed above. The system 200 comprises logic, circuits, devices, or program instructions, or a combination of logic, circuits, devices, or program instructions, or equivalent elements that are employed to execute the functions and operations according to the present invention as noted. The elements employed to accomplish these operations and functions within the system 200 may be shared with other circuits, program instructions, etc., that are employed to perform other functions and/or operations within the system 200.

Portions of the present invention and corresponding detailed description are presented in terms of software, or algorithms and symbolic representations of operations on data bits within a computer memory. These descriptions and representations are the ones by which those of ordinary skill in the art effectively convey the substance of their work to others of ordinary skill in the art. An algorithm, as the term is used here, and as it is used generally, is conceived to be a self-consistent sequence of steps leading to a desired result. The steps are those requiring physical manipulations of physical quantities. Usually, though not necessarily, these quantities take the form of optical, electrical, or magnetic signals capable of being stored, transferred, combined, compared, and otherwise manipulated. It has proven convenient at times, principally for reasons of common usage, to refer to these signals as bits, values, elements, symbols, characters, terms, numbers, or the like.

It should be borne in mind, however, that all of these and similar terms are to be associated with the appropriate physical quantities and are merely convenient labels applied to these quantities. Unless specifically stated otherwise, or as is apparent from the discussion, terms such as “processing” or “computing” or “calculating” or “determining” or “displaying” or the like, refer to the action and processes of a computer system, a microprocessor, a central processing unit, or similar electronic computing device, that manipulates and transforms data represented as physical, electronic quantities within the computer system's registers and memories into other data similarly represented as physical quantities within the computer system memories or registers or other such information storage, transmission or display devices.

Note also that the software implemented aspects of the invention are typically encoded on some form of program storage medium or implemented over some type of transmission medium. The program storage medium may be electronic (e.g., read only memory, flash read only memory, electrically programmable read only memory), random access memory magnetic (e.g., a floppy disk or a hard drive) or optical (e.g., a compact disk read only memory, or “CD ROM”), and may be read only or random access. Similarly, the transmission medium may be metal traces, twisted wire pairs, coaxial cable, optical fiber, or some other suitable transmission medium known to the art. The invention is not limited by these aspects of any given implementation.

The particular embodiments disclosed above are illustrative only, and those skilled in the art will appreciate that they can readily use the disclosed conception and specific embodiments as a basis for designing or modifying other structures for carrying out the same purposes of the present invention, and that various changes, substitutions and alterations can be made herein without departing from the scope of the invention as set forth by the appended claims.

What is claimed is:

1. A mechanism for determining device participation in an energy management program, comprising:
a network operations center (NOC), that commands one or more energy control devices to change one or more states responsive to energy management program events, wherein said one or more energy control devices respond to said NOC to indicate changed one or more states; and
a device accountability system, coupled to said NOC, that intercepts commands/responses from/to said NOC, and that creates a time-correlated model comprising program participation parameters for each of said one or more energy control devices, wherein said time-correlated model is based upon message characteristics for said commands/responses, communications network and transport layer operating characteristics, device data for said one or more energy control devices, and NOC data corresponding to said energy management program events and operator intervention events.

2. The mechanism as recited in claim 1, wherein said device accountability system generates one or more reports indicating said program participation parameters.

3. The mechanism as recited in claim 1, wherein said device accountability system correlates said NOC data corresponding to said energy management program events with said commands/responses to determine said program participation parameters, and wherein said program participation parameters are determined based on transmission/receipt of a last message in the presence of a communications disruption.

4. The mechanism as recited in claim 3, wherein said device accountability system, upon interception of a communications error message, obtains viable communications networks for a given device.

5. The mechanism as recited in claim 4, wherein said device accountability system initiates a message to said NOC to utilize a next viable communications network to communicate with a given device.

6. The mechanism as recited in claim 3, wherein said device accountability system, upon interception of a device error message, communicates with a given device to correct one or more device errors.

7. The mechanism as recited in claim 1, wherein said device accountability system initiates a message to said NOC indicating safe operation data to ensure a given device operates safely during said energy management program events.

8. A device participation and accountability apparatus, comprising:
a network operations center (NOC), that commands one or more energy control devices to change one or more states responsive to energy management program events, wherein said one or more energy control devices respond to said NOC to indicate changed one or more states, said NOC comprising:
a device accountability system, that intercepts commands/responses from/to said NOC, said device accountability system comprising:
a modeling element, that creates a time-correlated model comprising program participation parameters for each of said one or more energy control devices, wherein said time-correlated model is based upon message characteristics for said commands/responses, communications network and transport layer operating characteristics, device data for said one or more energy control devices, and NOC data corresponding to said energy management program events and operator intervention events.

9. The mechanism as recited in claim 8, wherein said device accountability system generates one or more reports indicating said program participation parameters.

10. The mechanism as recited in claim 8, wherein said modeling element correlates said NOC data corresponding to said energy management program events with said commands/responses to determine said program participation parameters, and wherein said program participation parameters are determined based on transmission/receipt of a last message in the presence of a communications disruption.

11. The mechanism as recited in claim 10, wherein said device accountability system comprises:
a communications error recovery service element, that, upon interception of a communications error message, obtains viable communications networks for a given device.

12. The mechanism as recited in claim 11, wherein said communications error recovery service element initiates a message to said NOC to utilize a next viable communications network to communicate with a given device.

13. The mechanism as recited in claim 10, wherein said device accountability system comprises:
a device error recovery service element, that, upon interception of a device error message, communicates with a given device to correct one or more device errors.

14. The mechanism as recited in claim 8, wherein said device accountability system comprises:
a safe operation control service element, that initiates a message to said NOC indicating safe operation data to ensure a given device operates safely during said energy management program events.

15. A method for determining device participation in an energy management program, comprising:
from a network operations center (NOC), commanding one or more energy control devices to change one or more states responsive to energy management program events, wherein the one or more energy control devices respond to the NOC to indicate changed one or more states; and
intercepting commands/responses from/to the NOC, and creating a time-correlated model comprising program participation parameters for each of the one or more energy control devices, wherein the time-correlated model is based upon message characteristics for the commands/responses, communications network and transport layer operating characteristics, device data for the one or more energy control devices, and NOC data corresponding to the energy management program events and operator intervention events.

16. The method as recited in claim 15, further comprising:
generating one or more reports indicating the program participation parameters.

17. The method as recited in claim 15, further comprising:
correlating the NOC data corresponding to the energy management program events with the commands/responses to determine the program participation parameters, wherein the program participation parameters are determined based on transmission/receipt of a last message in the presence of a communications disruption.

18. The method as recited in claim 17, further comprising:
upon interception of a communications error message, obtaining viable communications networks for a given device.

19. The method as recited in claim 18, further comprising:
initiating a message to the NOC to utilize a next viable communications network to communicate with a given device.

20. The method as recited in claim 17, further comprising:
upon interception of a device error message, communicating with a given device to correct one or more device errors.

21. The method as recited in claim 15, further comprising:
initiating a message to the NOC indicating safe operation data to ensure a given device operates safely during the energy management program events.
